(19) United States
(12) Patent Application Publication
(10) Pub. No.: US 2009/0320552 A1
(43) Pub. Date: Dec. 31, 2009

(54) Parallel flow meter device for measuring flow rate in pipes

(76) Inventor: Zohrab A. Samani, Las Cruces, NM (US)

Correspondence Address: Zohrab A. Samani, 2705 Claude Dove, Las Cruces, NM, 80111, US

(21) Appl. No.: 12/456,673

(22) Filed: Jun. 19, 2009

Related U.S. Application Data
(60) Provisional application No. 61/132,492, filed on Jun. 19, 2008.

(51) Int. Cl. G01F 15/02; G01F 25/00

(52) U.S. Cl. 73/1.16; 73/198

(57) ABSTRACT

The present invention relates to methods and apparatuses for measuring flow rate in pipes. The standard method of installing flow meters inside pipes to measure flow rates are costly and result in loss of energy and reduction of flow. The present invention solves the problems of standard flow measuring method. The present invention uses an apparatuses comprising of a first pipe and a by-pass second pipe. The flow is partitioned between the first pipe and the by-pass second pipe. A flow meter is installed in the by-pass second pipe. The flow rate is measured through the by-pass second pipe, and using the by-pass second pipe flow rate, the combined flow rate through the first pipe and the by-pass second pipe is calculated. The invention describes two methods to calibrate the apparatuses and relate the flow rate in the by-pass second pipe to total combined flow rate.

This application claims priority to U.S. Provisional Patent Application Ser. No. 61/132,492 entitled “Description of a Parallel Flow Meter Device to Measure Liquid or Gas Flow in Pipes,” filed on Jun. 19, 2008, and the specification of that application is incorporated herein by reference. This is a substitute specification and contains no new matter.

### BACKGROUND OF INVENTION

Field of Invention (Technical Field)

The present invention relates to method and apparatuses for measuring flow rates of liquid or gas in pipes, resulting in lower equipment cost and lower energy cost.

### BRIEF SUMMARY OF THE INVENTION

The present invention relates to an apparatus and method of measuring flow rate in pipes. The embodiment is described below.

Traditionally, flow rates of liquid or gas flowing through a pipe is measured by installing a flow meter inside the pipe. The flow meter measures the flow rate and total cumulative flow passing through the pipe. This method of flow measurement has several disadvantages. The flow meters are expensive. The cost of flow meters increases as the flow rate or pipe size increases. The flow meter also acts like an impediment to the flow and creates a large energy loss (head loss). The energy loss also results in reducing flow rate through the pipe.

The problem of accurately measuring a flow rate through a first pipe equipped with a first flow meter is solved by removing the first flow meter from the first pipe, mounting on the first pipe a by-pass second pipe dimensionally smaller than the first pipe, installing in the by-pass second pipe a second flow meter, directing a portion of the flow of the first pipe through the by-pass second pipe and the second flow meter, determining the second pipe flow rate, and using the second pipe flow rate to calculate the combined flow rate through the first pipe and by-pass second pipe.

The invention eliminates the disadvantages of measuring flow rate through a first pipe by using a small flow meter on a small by-pass pipe. The flow in the first pipe partitions between the first pipe and the by-pass second pipe. The partitioning of the flow is based on two principles of fluid mechanics; the conservation of energy and the conservation of mass. The principles of fluid mechanics is then used to relate the flow rate of the by-pass pipe to the combined flow rate through the first pipe and the by-pass second pipe.

The invention reduces the cost of equipment by using a smaller flow meter and reduces the cost of energy by removing the obstruction from the first pipe. For example, a propeller type flow meter installed in an 8 inch pipe with flow rate of 1000 gpm of water will cost about $2700 and will result in energy loss of 22 psi (51 feet). Using a by-pass one inch diameter second pipe, will require a flow meter which costs $85 and results in no additional head loss. There is no additional head loss because there will be no obstruction in the first pipe.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic representation of a cross-section of an embodiment of the unit of measurement of the present invention;

FIG. 2 is a graph showing a typical calibration curve for the parallel flow meter;

### DETAILED DESCRIPTION OF THE INVENTION

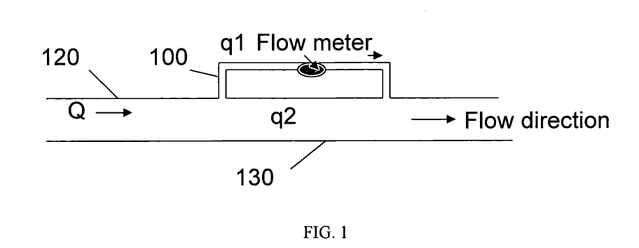

The present invention provides a system and method for measuring flow rate in pipes. The embodiment of the present invention consist of a system of parallel pipes where the flow of liquid or gas is partitioned between parallel pipes as shown in FIG. 1.

The invention provides a way of measuring flow rate at lower cost.

As used in the specification and claims herein, the terms “a”, “an”, and “the” means one or more. The term “liquid” means continuous amorphous substance that tends to flow and to conform to the outline of its container, such as water, petroleum or any other liquid. The term gas refers to a state of the matter, consisting of a collection of particles (molecules, ions, electrons, etc.) without a definite shape or volume that are in more or less random motion, such as air.

Traditionally, flow rates of liquid or gas flowing through a pipe such as water flowing out of a pump, is measured by installing a flow meter inside the pipe. Propeller meter is a commonly used flow meter used for this purpose. There are other types of flow meters. The flow meter measures flow rate and calculates total volume of liquid or gas which passes through the pipe. These flow meters have several disadvantages as follows; The capital cost is high. The flow meter creates a high head loss. The amount of head loss depends on flow rate and the size of the flow meter. For example, a propeller type flow meter installed in an 8 inch pipe with flow rate of 1000 gpm of water will cost about $2700 and will result in energy loss of 22 psi (51 feet). The flow meter acts like an obstruction resulting in loss of energy. The energy loss (head loss) created by the flow meter inside the pipe results in loss of pressure and flow in the system.

The problems of measuring flow rate through a first pipe equipped with a first flow meter is solved by removing the first flow meter from the first pipe, mounting on the first pipe a by-pass second pipe dimensionally smaller than the first pipe, installing in the by-pass second pipe a second flow meter, directing a portion of the flow of the first pipe through the by-pass second pipe and the second flow meter, determining the second pipe flow rate, and using the second pipe flow rate to calculate the combined flow rate through the first pipe and the by-pass second pipe.

The proposed invention eliminates the disadvantages described above by using a small flow meter installed in a small by-pass pipe parallel to the first pipe (FIG. 1). The flow in the first pipe partitions between the first pipe and the small by-pass second pipe based on the principle of conservation of energy and conservation of mass. The partitioning depends on the friction losses and minor losses in each pipe.

FIG. 1 shows how the total flow (Q) partitions between the by-pass pipe 100 and the first pipe 130. A small flow meter installed in the small by-pass pipe 100 measures the flow rate q1. Once q1 is measured, the flow rate through the pipe 130, q2, and pipe 120, Q, are calculated as described below.

As the total flow, Q, partitions between the two pipes 100 and 130, two equations are used to describe the process. According to principle of conservation of mass;

Q=q1+q2 (1)

Where q1 is flow through pipe 100 and q2 is flow through pipe 130. Since the head loss through pipe 100 and pipe 130 are equal, we can write;

$$\frac{{f}_{1} \cdot {l}_{1}}{{d}_{1}} \cdot \frac{{( {v}_{1} )}^{2}}{2 g} + [ {\sum }_{1}^{n} ( k ) ] \cdot ( \frac{{( {v}_{1} )}^{2}}{2 g} = \frac{{f}_{2} \cdot {l}_{2}}{{d}_{2}} \cdot \frac{{( {v}_{2} )}^{2}}{2 g} \qquad ( 2 )$$

where subscripts 1 represent pipe 100 and subscript 2 represent pipe 130.
“f” is friction factor in Darcy-Weisbach equation.
“L” is the pipe length
“d” is the pipe diameter
“v” is velocity of flow in the pipe
“g” is the acceleration of gravity (32.2 ft/s2)

$$“ {\sum }_{1}^{n} k ”$$

is sum of minor loss coefficients in the by-pass pipe
The velocity in each pipe is calculated by dividing the flow rate by cross-sectional area of the pipe. Equations 1 and 2 can be solved simultaneously to calculate q₁, q₂, and Q, provided that the sum of minor loss coefficients

$$“ {\sum }_{1}^{n} k ”$$

is known.

The sum of minor loss coefficients in the by-pass pipe is determined experimentally in the laboratory or in the field, by passing a fixed flow rate through pipe 120 and measuring flow rate through the by-pass pipe 100. The flow rate through pipe 130 is then calculated by subtracting flow rate of pipe 100 from flow rate of pipe 120. Once the flow rates through pipes 100, 120 and 130 are known, equations 1 and 2 described in [0019] are solved simultaneously to calculate the sum of minor loss coefficients in the by-pass pipe. Once the sum of minor loss coefficients are determined, a calibration table or a calibration curve for the parallel flow meter is developed by simultaneously solving equations 1 and 2 described in [0019], for various flow rates.

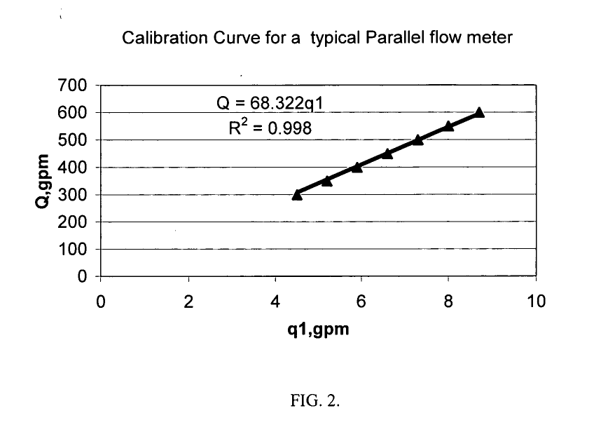

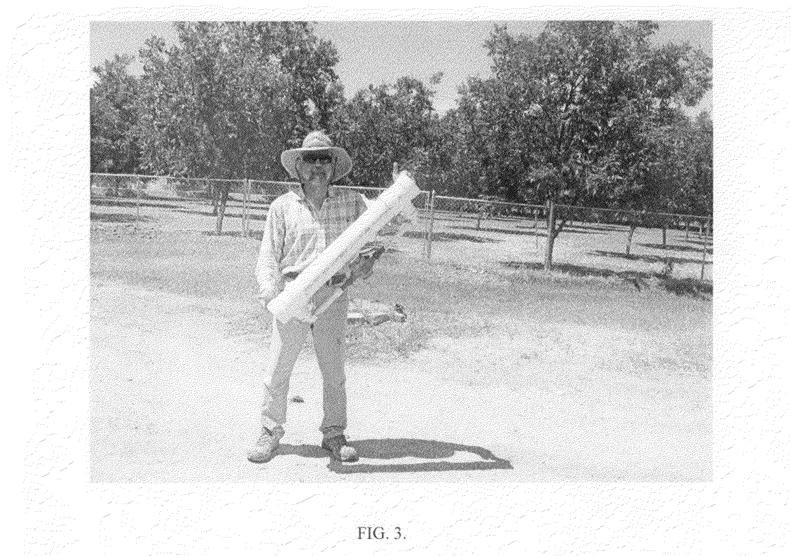

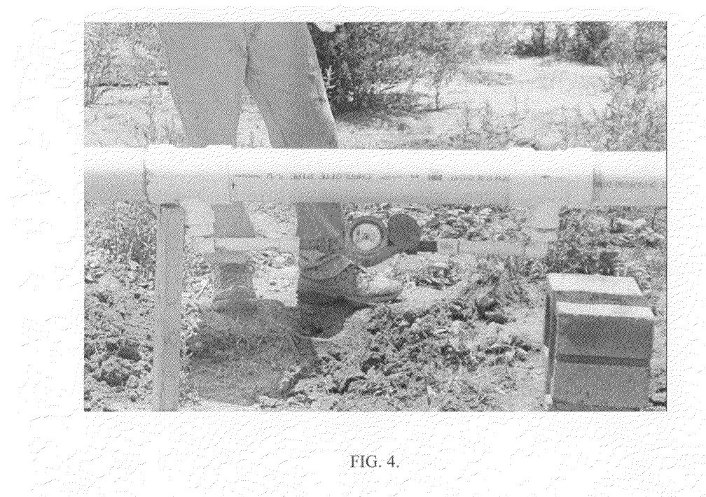

FIG. 2 is a graph showing a typical calibration curve for a parallel flow meter for measuring water, where the by-pass pipe has diameter of 1 inch and the main pipe has diameter of 4 inches.

Another method to develop calibration curve for the parallel flow meter shown in FIG. 1, is by passing various known flow rates through pipe 120 and measuring the flow rate rates in pipe 100 either in the laboratory or in the field.

What is claimed is:

1. An apparatus for measuring flow through pipes comprising:
a first pipe;
a by-pass second pipe; and
a flow meter installed in the by-pass second pipe.

2. The apparatus of claim 1 wherein flow is partitioned between a first pipe and a by-pass second pipe

3. The apparatus of claim 1 wherein a flow meter is installed in the by-pass second pipe.

4. The apparatus of claim 1 wherein flow rate and total flow is measured in the by-pass second pipe and used to calculate the combined flow through the first pipe and the by-pass second pipe.

5. Two methods of developing calibration table, calibration graph or calibration equation relating the flow rate of the by-pass second pipe to the combined flow rate through the first pipe and the by-pass second pipe. The two calibration methods comprise of:
Experimentally determining the sum of minor loss coefficients through the by-pass second pipe and using it to calculate calibration table, calibration graph or calibration equation.
Experimentally determining a calibration table, calibration graph or calibration equation by measuring various flow rates through the first pipe and the by-pass second pipe.
